(19) United States
(12) Patent Application Publication
(10) Pub. No.: US 2006/0055148 A1
(43) Pub. Date: Mar. 16, 2006

(54) Articulating motorcycle leg-rest

(76) Inventor: Michael Howard Patch, LaGrange, GA (US)

Correspondence Address: Michael Howard Patch, 111 Montrose Way, LaGrange, GA, 30240, US

(21) Appl. No.: 10/937,480

(22) Filed: Sep. 10, 2004

(51) Int. Cl. B62J 39/00

(52) U.S. Cl. 280/288.4; 280/304.4

(57) ABSTRACT

A motorcycle leg-rest to support the rider's legs during long cruises providing increased comfort and reduced fatigue. The leg-rest position is adjustable to accommodate rider size and preference. Mounted at a height where it will not strike the ground while cornering, but low enough to be in safe proximity to the foot controls, the leg-rest offers a preferable alternative to the common rider practice of resting the legs higher up than the foot pegs on the frame, fairing, etc. When not in use, the leg-rest is safely out-of-place to avoid any interference with normal operation. During use, the rider's leg lies on a smooth, cushioned, slightly concave pad. The construction and shape of the pad provides the benefit of reduced muscle fatigue and joint stress.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates to footrests for motorcycles. Specifically, it is actually an improvement on footrests for long rides since it supports the rider's leg with an adjustable structure that mounts to the motorcycle frame.

Riders typically sit astride the motorcycle with their feet resting on foot pegs, floorboards or a composite design of the two. Foot pegs are the simplest and most commonly used type of rest. They are placed low and slightly forward for the most common riding position, or higher and more forward for longer, cruising rides where gear shifting is infrequent. In both cases, the rider's legs are supported through a small concentrated area on the bottom of the foot. The support forces are transferred through the ankle and knee joints. Floorboards offer a more comfortable rest by distributing the support forces across the entire bottom of the foot. However, the load is still transferred through the ankle and knee joints. A composite design incorporating booth foot peg and floorboard, or separate mountings of both types on the motorcycle, give the rider the option of position changes. However, in all cases, the leg support is transferred through the rider's foot. On very long rides, the rider's muscles and joints are subjected to forces and vibrations that can be fatiguing and potentially injurious. The lack of a more suitable leg-rest has led to the observation of riders on the highways with their legs laid on the motorcycle's fairings, frames, etc. This situation is both unsafe and insufficient since the positions are usually not optimum for the rider's comfort and the legs are either not restrained from falling, or too restrained for quick return to the foot controls. There is, therefore, a need in the art to provide a design with more effective leg-support for long rides that improves both comfort and safety.

Following is listed the relevant U.S. patents from a search:

| | | | |
|---|---|---|---|
| 1261442 | April 1918 | Rigby | 280/291 |
| 3960027 | June 1976 | Magnuson | 74/594 |
| 4174852 | November 1979 | Panzica et al. | 280/291 |
| 4401315 | August 1983 | Pavincic | 280/259 |
| 4546993 | October 1985 | Walker | 280/291 |
| 4802684 | February 1989 | Bennett et al. | 280/291 |
| D388366 | December 1997 | Nishino | D12/110 |
| 5779254 | July 1998 | James et al. | 280/291 |
| 5826900 | October 1998 | Steele | 280/291 |
| 5893424 | April 1999 | Hisada | 180/90 |
| 6142499 | November 2000 | Hsieh et al. | 280/291 |
| 6173983 | January 2001 | Moore | 280/291 |
| 6499378 | December 2002 | Ho | 74/564 |
| 6578652 | June 2003 | Kobacker | 180/219 |
| 6719316 | April 2004 | Anthony | 280/291 |

### SUMMARY OF THE INVENTION

To surmount the deficiencies in the art of motorcycle footrests, this leg-rest system has been devised. It provides increased comfort on long rides by supporting the rider's legs between the ankle and knee, in the adjustable position preference of the rider, on a cushioned pad, Through an articulating linkage arrangement, the leg-rest position is widely adjustable to accommodate different rider anatomies and preferences. The rest pad is shaped in a concave manner to provide a passive restraint that prevents the rider's legs from falling, but without preventing a quick return to foot controls. The cushioned pad dampens and eliminates forces and vibrations on the foot, ankle and knee that can cause fatigue and cumulative stress injuries. The leg support position is adjustable forward (from the rider), in and out (from centerline of the motorcycle), and rotatable in both vertical and horizontal axes. Construction and operation of the invention are apparent in more detail to those of skill in the art from the following drawings and description.

### BRIEF DESCRIPTION OF THE DRAWINGS

FIG. 1 is a Top and Side orthographic view of the invention. The rotational adjustments are shown with arrowed phantom lines.

### DETAILED DESCRIPTION OF THE INVENTION

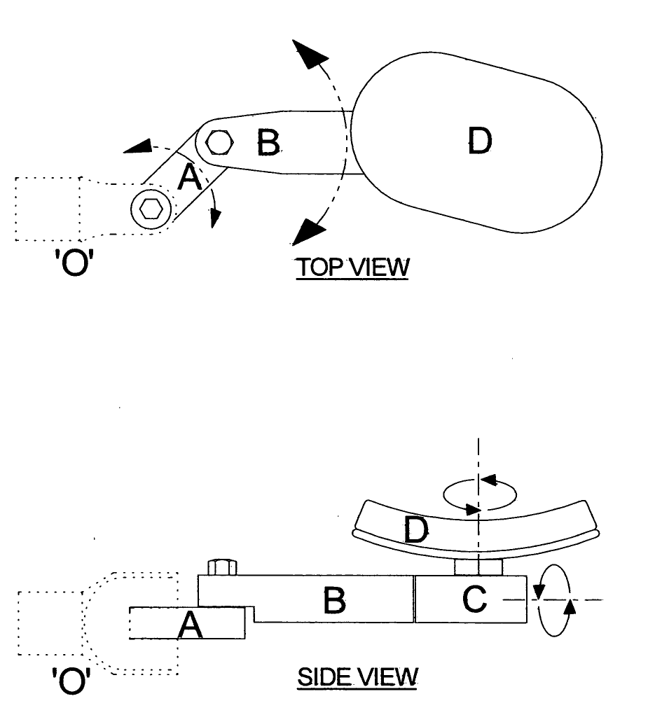

Referring to FIG. 1, the assembled links ‘A’ and ‘B’ are shown to be adjustable by their lockable pivot points. Their rotational positioning is represented by the phantom arrow lines in the Top View. By rotating and locking the links ‘A’ and ‘B’ in place, the leg rest can be positioned at various distances forward on the motorcycle and various distances from the motorcycle. The leg-rest pad, ‘D’, is shown in both views to be adjustable by rotation and locking on two axes—horizontal and vertical. These adjustments provide the optimum positioning of the leg support for different riders. The phantom component, ‘O’, represents any of the many attachments available for mounting the Leg-Rest to the many models of motorcycles.

Part ‘D’ is a leather covered cushion mounted to a concave curved base. The concavity is sized to provide a passive restraint for the rider's leg without restricting ease of movement on and off. The cushioned pad distributes and softens the stress on the leg muscles and joints. ‘D’ can be rotated and locked in block ‘C’, and ‘C’ can be rotated and locked in link ‘B’. All parts are of non-corrosive materials or are coated or plated with non-corrosive materials to last in the outdoor environment.

It should be understood that there may be other modifications and changes to this invention will be obvious to those of skill in the art from the foregoing description. However, this invention should be limited only by the following claims and their legal equivalents.

1. A motorcycle leg-rest that mounts to any touring/cruiser motorcycle frame and is widely adjustable in position to accommodate differences in rider anatomy and preference.

2. The leg-rest of claim 1 includes a cushioned pad that softens and distributes the stresses of long rides on the feet and legs.

3. The leg-rest of claim 1 is designed to be mounted high enough so as not to interfere with normal operation or cause rigid grounding during vehicle cornering.

4. The leg-rest of claim 1 can be folded in against the motorcycle when not in use.

5. The cushioned pad of claim 2 has a concave surface to passively restrain the rider's leg from falling off during use, without hindering ease of return of the rider's feet to the foot controls.

6. The leg-rest of claim 1 is constructed of variable length, pivoting links and a two-axis adjustable leg support.

7. The leg-rest of claim 1 is constructed of materials designed to withstand outdoor elements.

8. The leg-rest of claim 1 is designed to support the rider's legs between the ankle and knee to take the support loads off the feet, ankle and knee. Therefore, fatigue and cumulative stress injuries from long rides can be alleviated.
